(19) United States
(12) Patent Application Publication
(10) Pub. No.: US 2026/0276016 A1
(43) Pub. Date: Sep. 17, 2026

(54) Telescopic Tube, Telescopic Rod Incorporating the Same and Application thereof

(71) Applicant: PGYTECH CO.,LTD, Jiangsu (CN)

(72) Inventors: Lifeng ZHANG, Jiangsu (CN); Shilei ZHU, Jiangsu (CN); Xiuzhi YU, Jiangsu (CN)

(73) Assignee: PGYTECH CO.,LTD, Jiangsu (CN)

(21) Appl. No.: 19/561,667

(22) Filed: Mar. 10, 2026

(30) Foreign Application Priority Data
Mar. 12, 2025 (CN) 2025102879990

(51) Int. Cl. F16B 7/14

(52) U.S. Cl. CPC F16B 7/1463

(57) ABSTRACT

Disclosed is a telescopic tube, comprising an inner tube, an outer tube and a locking mechanism located therebetween. The locking mechanism comprises a fixed base secured to an end of the inner tube, a sliding frame arranged inside the outer tube and slidable axially, and an expansion block arranged near the outer tube. The sliding frame is in helical fit with the fixed base along a centerline. When the inner and outer tubes are extended, the expansion block is driven to approach the fixed base, generating an interference force that causes the expansion block to expand outward and press tightly against the outer tube for locking; when rotated, the inner tube drives the sliding frame to move axially, allowing the expansion block to move away from the fixed base and recess inward to disengage from the outer tube for unlocking, with a rotation angle not exceeding 270°.

### CROSS-REFERENCE TO RELATED APPLICATIONS

This application claims priority to Chinese Disclosure Patent Application No. 202510287999.0, filed on March 12, 2025, entitled " Telescopic Tube and Telescopic Rod incorporating the same, and Application thereof", the content of which, including the amendments, is incorporated herein by reference in its entirety,

### TECHNICAL FIELD

The present disclosure relates to the technical field of telescopic tubes used in various scenarios such as photographic equipment assistance, and specifically relates to a telescopic tube, a telescopic rod incorporating the same and an application thereof.

### BACKGROUND

In the prior art, telescopic tubes, as commonly used accessories, are widely applied in various products, such as trekking poles, mops, tripods, and table legs. Conventional telescopic tubes are mostly configured with mechanical knobs, for example, in the patent with application number CN2024209201310, titled " Tripod of Astronomical Telescope", its telescopic tube leg includes an outer tube and an inner tube that are capable of sliding relative to each other for extension and retraction, with a clamping groove set on the outer tube; the lower end of the outer tube is provided with an eccentrically arranged adjustment handle. In this entire structure, not only is an exposed adjustment handle required, but the eccentric arrangement makes the entire operation complex, and the exposure of the adjustment handle affects the overall aesthetics.

### SUMMARY

The present disclosure provides a telescopic tube and a telescopic rod incorporating the same, as well as applications, to address the issues raised in the above background art.

To achieve the above object, the present disclosure adopts the following technical solutions:

The present disclosures provides a telescopic tube, including: an inner tube, an outer tube, and a locking mechanism located between the inner tube and the outer tube, wherein the locking mechanism comprises a fixed base secured to an end of the inner tube, a sliding frame disposed inside the outer tube and sliding axially along the outer tube, and an expansion block arranged adjacent to the outer tube, wherein the sliding frame and the fixed base are in helical fit in direction along a centerline of the telescopic tube, and when the inner tube and the outer tube are extended to any position, the sliding frame drives the expansion block to approach the fixed base, while an interference force is generated between the expansion block and the fixed base, enabling the expansion block to expand outward and tightly interfere with the outer tube;

when the inner tube rotates, the fixed base rotates with a center of the inner tube as an axis, pushing the sliding frame to slide axially, the inner tube and the outer tube retract, the expansion block moves away from the fixed base, the expansion block recesses inward and approaches the sliding frame, and tends to disengage from interference with the outer tube, wherein a rotation range of the inner tube is less than or equal to 270°.

The beneficial effects of the present disclosure compared to the prior art are as follows:

In the present disclosure, the inner tube and the outer tube, through the action of the sliding frame and the fixed base, control the expansion block to lock or unlock. The entire structure is arranged inside the telescopic tube without being exposed, achieving frictional interaction with the outer tube, thereby enabling locking or unlocking of the outer tube, allowing the inner tube to be adjusted by being locked or unlocked, with simple operation.

In the present disclosure, the relevant unlocking process is completed through simple rotation, greatly improving unlocking efficiency and providing a better user experience.

### BRIEF DESCRIPTION OF DRAWINGS

The drawings, which form a part of this application, are provided to further illustrate the present disclosure. The illustrative embodiments and the descriptions thereof are used to explain the present disclosure and do not constitute an improper limitation thereof. In the drawings:

FIG. 1 is a cross-sectional view of a telescopic tube provided by the present disclosure;

FIG. 2 is an exploded view of a telescopic tube provided by the present disclosure;

FIG. 3 is an assembly diagram of the sliding frame, fixed base, and expansion block in Embodiment 1 provided by the present disclosure;

FIG. 4 is an exploded view of another telescopic tube provided by the present disclosure;

FIG. 5 is a cross-sectional view of another telescopic tube in an unlocked state provided by the present disclosure;

FIG. 6 is a cross-sectional view of another telescopic tube in a locked state provided by the present disclosure;

FIG. 7 is one of the schematic structural diagrams of the expansion block provided by the present disclosure.

FIG. 8 is a second structural schematic diagram of the expansion block provided by the present disclosure;

FIG. 9 is a structural schematic diagram of the sliding frame provided by the present disclosure;

FIG. 10 is a first structural schematic diagram of the fixed base provided by the present disclosure;

FIG. 11 is a second structural schematic diagram of the fixed base provided by the present disclosure;

FIG. 12 is an assembly diagram of the outer tube and the sliding frame provided by the present disclosure;

FIG. 13 is a structural schematic diagram of an infinitely adjustable telescopic rod provided by the present disclosure;

FIG. 14 is a structural schematic diagram of the tripod provided by the present disclosure.

Reference signs: 100, Inner Tube; 110, Inner End Cap; 200, Outer Tube; 210, Outer End Cap; 220, Sliding Block; 230, Edge Closing Structure; 300, Locking Mechanism; 310, Fixed Base; 311, Sliding Groove; 312, Rotating Part; 313, Screw Rod; 314, Elastic Member; 315, Base Seat; 316, Sliding Sleeve; 317, Limit Body; 320, Sliding Frame; 321, Limit Part; 322, Sliding Cavity; 323, Central Cylinder; 324, Limit Step; 325, Threaded Hole; 330, Expansion Block; 331, Preload Structure; 340, Interference Structure; 350, Sealing Gasket.

### DESCRIPTION OF EMBODIMENTS

The technical solutions in the embodiments of the present disclosure will be clearly and completely described below with reference to the accompanying drawings in the embodiments of the present disclosure. It is obvious that the described embodiments are only a part of the embodiments of the present disclosure, not all of them. The description of at least one exemplary embodiment below is illustrative in nature and is in no way intended to limit the disclosure, its application, or use. Based on the embodiments of the present disclosure, all other embodiments obtained by a person of ordinary skill in the art without creative effort shall fall within the scope of protection of the present disclosure.

It should be noted that the terminology used herein is for the purpose of describing specific embodiments only and is not intended to limit the exemplary embodiments according to the present application. As used herein, unless the context clearly indicates otherwise, the singular forms are intended to include the plural forms as well. Furthermore, it shall be appreciated that when the terms "comprise" and/or "include" are used in this specification, they indicate the presence of stated features, steps, operations, devices, components, and/or combinations thereof.

Unless specifically stated otherwise, the relative arrangement, numerical expressions, and numerical values of the components and steps set forth in these embodiments do not limit the scope of the disclosure. At the same time, it shall be appreciated that for ease of description, the dimensions of the various parts shown in the drawings are not drawn to actual scale. Techniques, methods, and devices known to those of ordinary skill in the relevant art may not be discussed in detail but should be considered part of the authorized specification where appropriate. In all examples shown and discussed herein, any specific value should be construed as illustrative and not as a limitation. Therefore, other examples of the exemplary embodiments may have different values. It should be noted that similar reference numerals and letters denote similar items in the following drawings, and therefore, once an item is defined in one drawing, it does not require further discussion in subsequent drawings.

### Embodiment 1

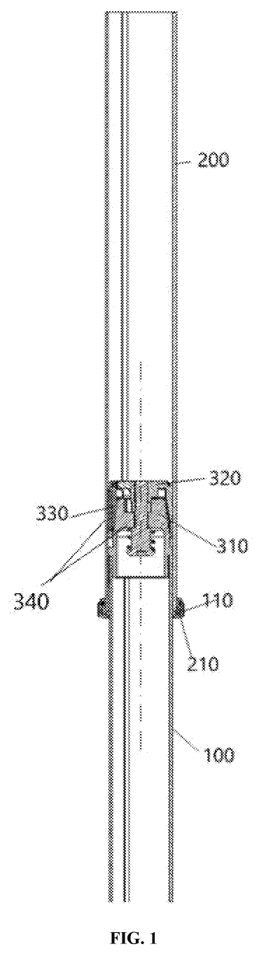

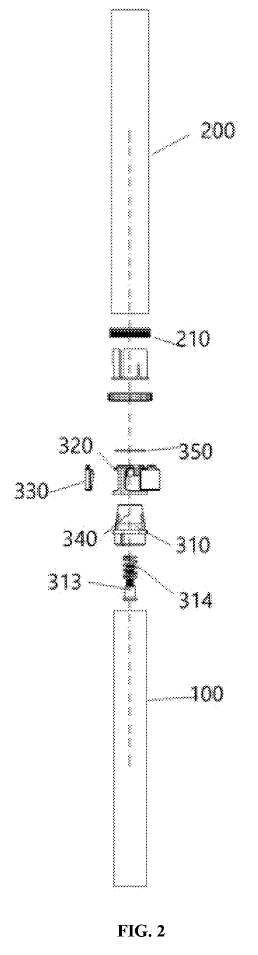

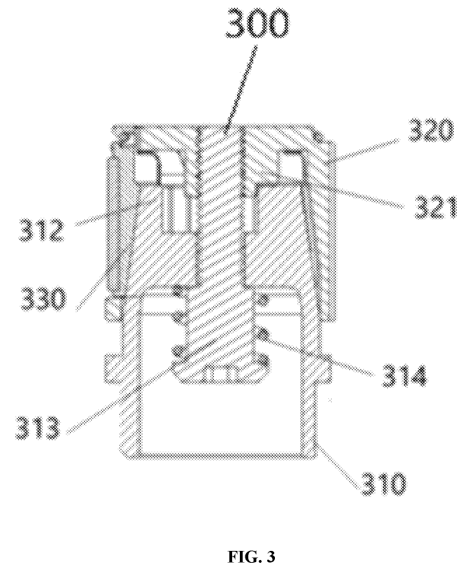

Referring to FIGS. 1-3, a telescopic tube in this embodiment includes an inner tube 100, an outer tube 200, and a locking mechanism 300 located between the inner tube 100 and the outer tube 200. Specifically, the locking mechanism 300 includes a fixed base 310 secured to an end of the inner tube 100, a sliding frame 320 disposed inside the outer tube 200 and slidable along the axial direction of the outer tube 200, and an expansion block 330 arranged adjacent to the outer tube 200. The sliding frame 320 and the fixed base 310 are in helical fit along the direction of the centerline of the telescopic tube. When the inner tube 100 and the outer tube 200 are extended to any position, the sliding frame 320 drives the expansion block 330 to approach the fixed base 310, while an interference force is generated between the expansion block 330 and the fixed base 310, enabling the expansion block 330 to expand outward and tend to tightly interfere with the outer tube 200.

Thus, the locking principle and process in this embodiment are as follows: when locking the inner tube 100 and the outer tube 200, it simply needs to pull outward to extend the inner tube 100 and the outer tube 200 axially. At this time, the fixed base 310 on the inner tube 100 moves away from the outer tube 200. Due to the helical fit between the fixed base 310 and the sliding frame 320, the sliding frame 320 is driven to move axially along the outer tube 200, bringing it closer to the fixed base 310. Simultaneously, the axial contact distance between the expansion block 330 adjacent to the outer tube 200 and the fixed base 310 increases, and the contact area consequently enlarges. This increases the interference force and mutual interaction force generated between them, forcing the expansion block 330 to expand outward, which increase the interference force with the outer tube 200, forming an initial locked state between the inner and outer tubes. In this process, any extension of the inner tube 100 and the outer tube 200 will drive the interaction between the fixed base 310 and the expansion block 330. The longer the extending distance, the greater the force, resulting in a tighter lock. When the axial interference force between them is at its maximum, further extension is no longer possible.

During unlocking, the inner tube 100 rotates, enabling the fixed base 310 to rotate positively (non-eccentric rotation) around the center of the inner tube 100. This rotation is the normal rotation of the inner tube 100 about its center. The sliding frame 320, which is helically engaged with the fixed base 310, is then driven to move away from the inner tube 100. Consequently, the sliding frame 320 causes the contact area between the expansion block 330 and the fixed base 310 to decrease, tending toward the unlocked state. Specifically, during rotation, the inner tube 100 and the outer tube 200 are in a retracted state. The fixed base 310 extends deeper into the outer tube 200 along with the inner tube 100. At this time, under the rotational force from the fixed base 310, the sliding frame 320 is driven to slide along the outer tube 200, moving away from the fixed base 310 and pulling the expansion block 330 away from it. The force between them then diminishes, and the expansion block 330 retracts closer to the inner tube 100, achieving unlocking.

In the unlocking process described above, the inner tube 100 does not require excessive rotation; that is, unlocking may be achieved with a rotation range of the inner tube 100 less than or equal to 270°, meaning less than one full turn. Furthermore, it may also be unlocked by rotating only 240°, 180°, 90°, 60° or 30.

In this embodiment, due to the different diameters of the inner tube 100 and the outer tube 200, they are able to continuously move relative to each other, and the sliding frame 320 is able to slide along the outer tube 200 indefinitely. Therefore, during locking, they may be extended infinitely to any position, and the aforementioned locking process will occur in each case.

As shown in FIGS. 1-3, this embodiment specifically controls the expansion block 330 to move closer to or away from the fixed base 310 through the relative relationship and motion process between the fixed base 310 and the sliding frame 320. In this embodiment, the periphery of the sliding frame 320 may be configured as an assembly space, allowing the expansion block 330 to be located within this assembly space, so that during the axial movement of the sliding frame 320, the expansion block 330 moves closer to or away from the fixed base 310. By limiting and supporting the expansion block 330, the sliding frame 320 ensures that the expansion block 330 be stably assembled and prevents it from moving arbitrarily within the telescopic tube.

### Embodiment 2

In this embodiment, the specific formation of the interference force is introduced.

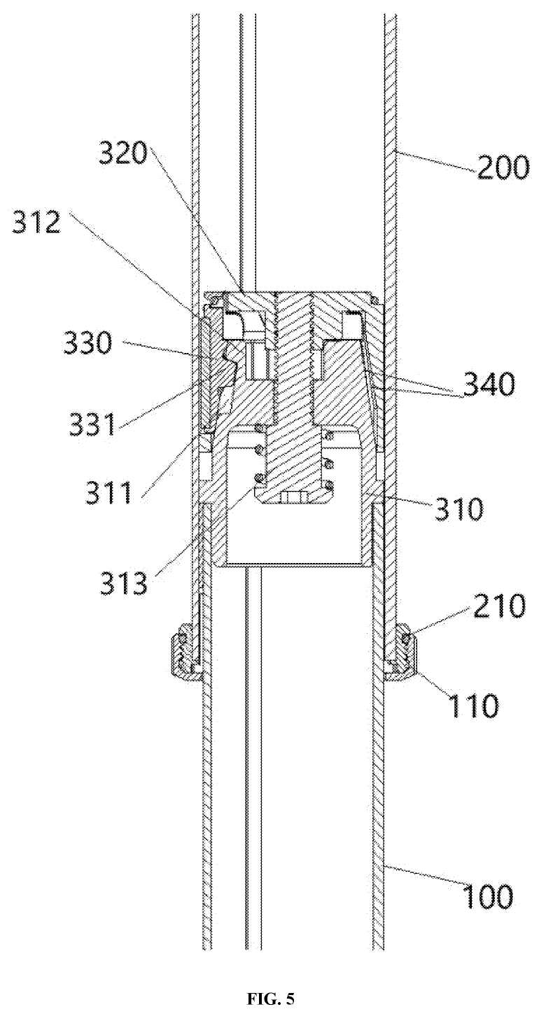

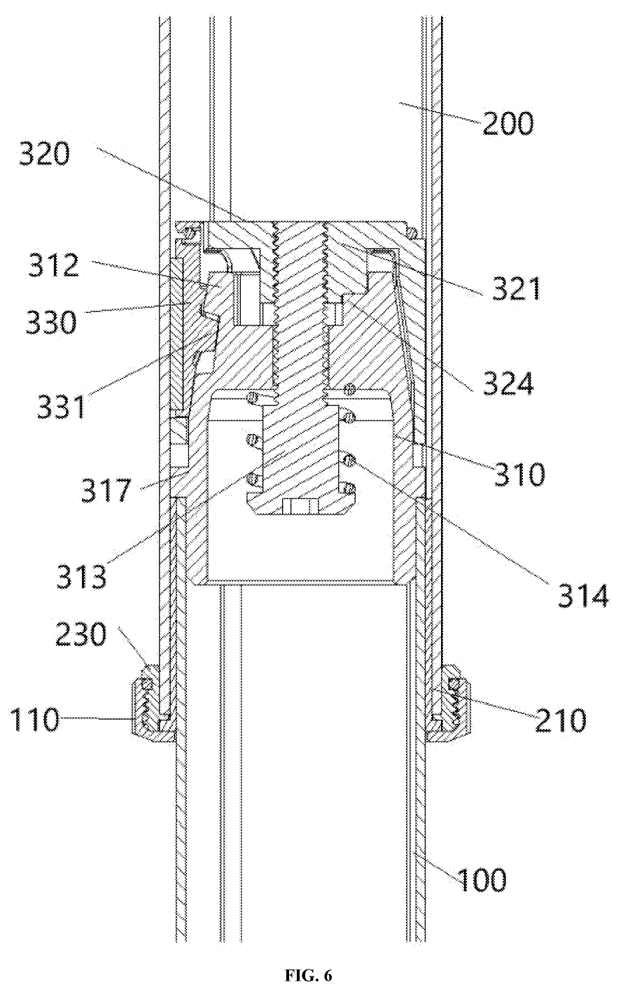

In this embodiment, as shown in FIGS. 1-6, to generate the interference force, an interference structure 340 is specifically formed. For example, using an inclined surface as the interference structure, when the inclined surface contacts a flat plane, or when two inclined surfaces interfere, due to the action of the inclined surfaces, one surface is pushed outward or conforms inward to the inclined surface. During this process, the inner wall of the expansion block 330 will move closer to or away from the fixed base 310 under the action of the inclined surface, achieving outward expansion and separation.

In this embodiment, the interference structure 340 may be set only on the fixed base 310, or on the inner wall of the expansion block 330, or simultaneously on both the fixed base 310 and the expansion block 330. In this case, during the movement of the inner tube, it will act on the fixed base 310, causing it to contact the expansion block 330 and realize the function of the interference structure. For example, during the extension of the inner tube 100 and the outer tube 200, if the fixed base 310 in the inner tube 100 moves downward, the sliding frame 320 is driven to slide downward, and the expansion block 330 on its outer side also moves closer to the fixed base 310. The gap between the inclined surfaces decreases, thereby bringing the sliding frame 320 and the fixed base 310 closer to each other, generating an interference force used to lock the inner tube 100 and the outer tube 200.

In this embodiment, the interference structure 340 may be arranged axially along the telescopic tube, forming an interference surface. The interference surface acts in the axial direction as the inner tube 100 and the outer tube 200 move closer or farther apart, increasing or adjusting the interference force. For example, when the inner tube 100 and the outer tube 200 move apart, the interference force increases, tending to be locked; when the inner tube 100 and the outer tube 200 move closer, the interference force decreases, tending to be unlocked.

In other embodiments (not shown), besides parallel inclined surfaces, the interference structure 340 may also adopt conical, spherical, curved, or stepped wedge surfaces, enabling the expansion block 330 to achieve different radial expansion curves during axial displacement to meet the segmented requirements from light to strong locking. The interference surface angle may be set within the range of 5°-30° to balance self-locking and unlocking feel; the contact area may be treated with sandblasting, knurling, hard anodizing, or wear-resistant coatings to enhance friction stability. Furthermore, micro-protrusions, chip removal grooves, or oil reservoirs may be provided on the contact surfaces to prevent slipping, reduce wear and noise, and improve reliability in sandy or muddy environments; an elastic buffer layer may also be added to the outer side of the expansion block 330 to enhance the feel.

### Embodiment 3

In this embodiment, the specific interference structure and the detailed structure of the fixed base are introduced.

In this embodiment, based on the interference structure 340 of Embodiment 2 in the axial direction, specifically, the interference structure 340 is an inclined surface that slopes from bottom to top, from the outer tube 200 toward the inner tube 100. When both the fixed base 310 and the expansion block 330 are provided with interference structures, the two inclined surfaces on the fixed base 310 and the expansion block 330 are arranged parallel. In this case, the interference surfaces are all inclined surfaces, which may exist on the outer wall of the fixed base 310, on the inner wall of the expansion block 330, or simultaneously on both. At this time, the two inclined surfaces are parallel. As the fixed base 310 and the sliding frame 320 approach each other, the gap between the two inclined surfaces gradually decreases until the end of the inclined surface at the fixed base 310 closest to the outer tube 200 contacts the end of the inclined surface at the expansion block 330 closest to the outer tube 200, and the other end of the fixed base 310 extends into the outer tube 200, at which time the insertion depth into the outer tube 200 reaches its maximum, while the other end of the expansion block 330 also extends into the bottom of the fixed base 310. The ends of both that are farthest from the centerline of the telescopic tube come into contact, resulting in the maximum mutual friction interference force.

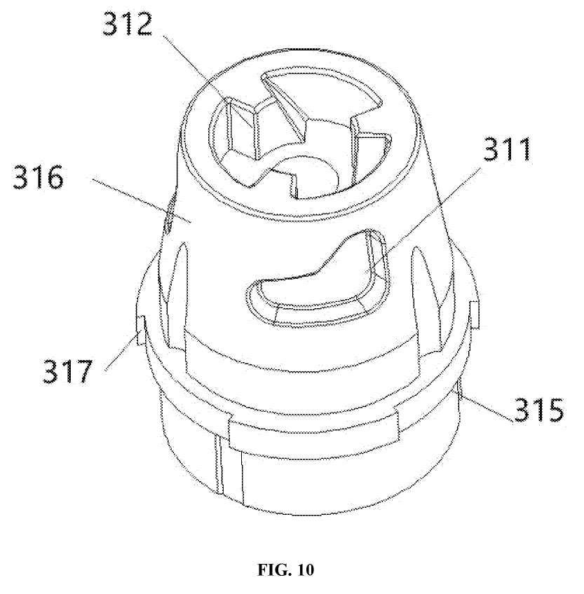

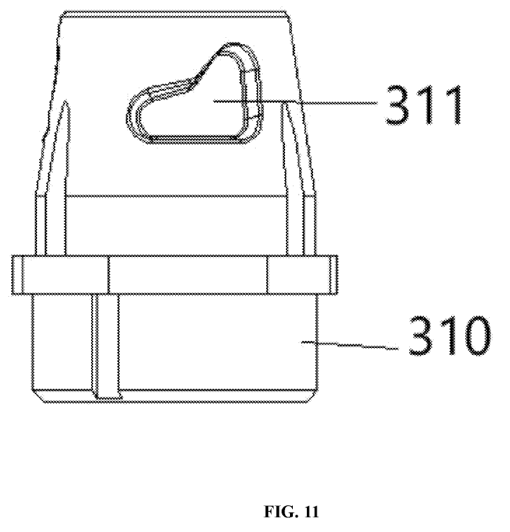

Referring to FIGS. 1-6 and 10-11, the fixed base 310 in this embodiment includes a base seat 315 and a sliding sleeve 316 extending from the base seat 315 toward the interior of the outer tube 200. The sliding sleeve 316 forms a necking cavity with a gradually decreasing diameter toward the outer tube 200. In this case, the inclined interference structure is directly formed on the necking cavity to interfere with the expansion block.

To generate an unlocking force, it also includes several rotating parts 312 extending toward the centerline of the telescopic tube inside the sliding sleeve 316, and limit parts 321 corresponding to the rotating parts 312 are provided inside the sliding frame 320. At this point, the relative motion between the two drives rotation to achieve unlocking.

Specifically, a limit step 324 facing the rotating part 312 is formed at the limit part 321, and the inner tube 100 during rotation drives the rotating part 312 located within the limit step 324 to disengage from the limit step 324. In actual rotation, the limit part 321 moves closer to or farther from the limit step 324 as it rotates; when rotated to a certain position, due to the presence of the limit step 324, it cannot continue to move upward closer, but is able to rotate in the opposite direction to move away, and this reverse rotation drives unlocking.

Specifically, an interference incline may also be provided on the outer wall of the limit step 324 and/or the inner wall of the rotating part 312. The purpose of the interference incline here is to assist in the contact or separation between the rotating part 312 and the limit step 324, aiding in completing the rotation.

In other embodiments (not shown), to improve the installation strength of the inner tube 100 and the fixed base 310 and ensure rotational coaxiality, the end of the inner tube 100 may be press-riveted to form a flange; after the flange fits with the annular shoulder on the periphery of the base seat 315, detachable locking is achieved via screws, blind rivets, or snap rings. Alternatively, a keyway or polygonal positioning surface may be formed on the inner wall of the inner tube 100, and a positioning key or corresponding flat surface may be set on the periphery of the base seat 315 to achieve anti-rotation positioning and axial limitation. Furthermore, a thickened sleeve, reinforcing ring, or spot-welded stiffener may be added at the connection, and anti-loosening adhesive may be applied or an elastic washer may be installed on the contact surface to enhance bending, torsion, and fatigue resistance, while reducing wobble caused by assembly gaps.

### Embodiment 4

Based on Embodiment 1, 2, or 3, this embodiment achieves how to increase locking, making the locking force larger and ensuring a better locking effect.

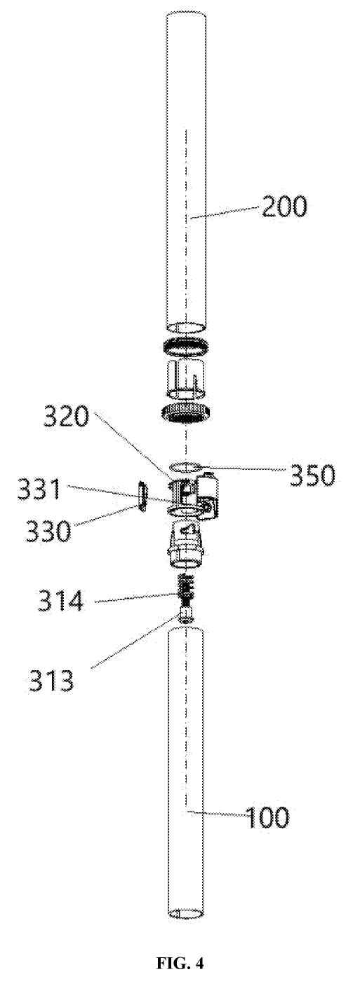

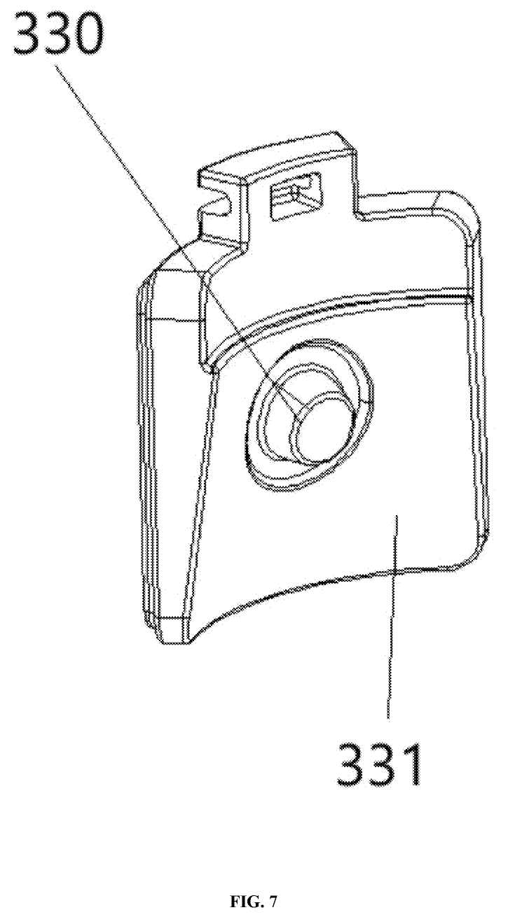

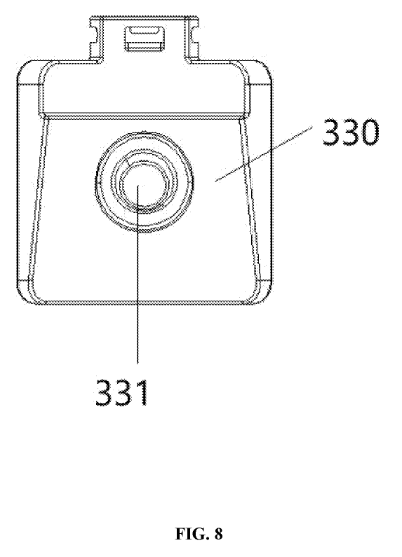

As shown in FIGS. 4-8, in this embodiment, a preload structure 331 is provided inside the expansion block 330, and a sliding groove 311 corresponding to the preload structure 331 is provided on the fixed base 310. By rotating the inner tube, the sliding groove 311 interacts with the preload structure 331, thereby increasing the interference force between them. For example, following the approach in Embodiment 2, this causes the two inclined surfaces to move further apart, resulting in a greater interference force. Consequently, the force driving the expansion block 330 outward is stronger, increasing contact with the outer tube 200. Here, the preload structure 331 may be a cylinder or similar, and the sliding groove 311 forms a downward motion, enabling the rotation of the inner tube 100 to drive the sliding frame 320 further downward. The inclined surface of the expansion block 330 moves further downward, enhancing the locking force.

In this embodiment, to coordinate with the rotation of the inner tube 100, the sliding groove 311 forms an arcuate trajectory with an upward and downward trend. The preload structure 331 then rotates along this arcuate trajectory, urging the expansion block 330 to abut and interfere with the outer tube 200.

In this embodiment, the sliding groove 311 is located on the outer wall of the sliding sleeve 316, while the rotating part 312 is located on the inner wall. Preferably, one is positioned in the middle-lower section and the other in the upper section to reduce strength weakening caused by simultaneous action.

In other embodiments (not shown), the preload structure 331 may be a roller, hemispherical head, cylindrical pin, or wedge-shaped protrusion to reduce rotational resistance and improve preload consistency. The preload structure 331 may be fixed within the expansion block 330 by press-fitting, screws, or insert molding. The sliding groove 311 may be a closed arcuate track, a S-shaped track, or a two-stage track, where the first stage is for quick preloading and the second stage is for strong locking and forms a non-return position. A limit end face may be provided inside the sliding groove to prevent over-rotation. Additionally, a guide cover plate or dust shield may be added outside the sliding groove to prevent foreign matter entry and restrict the preload structure from dislodging. A buffer zone may be set at the track ends to reduce impact, and an access hole may be reserved on the cover plate for easy cleaning.

### Embodiment 5

This embodiment primarily introduces the overall assembly process.

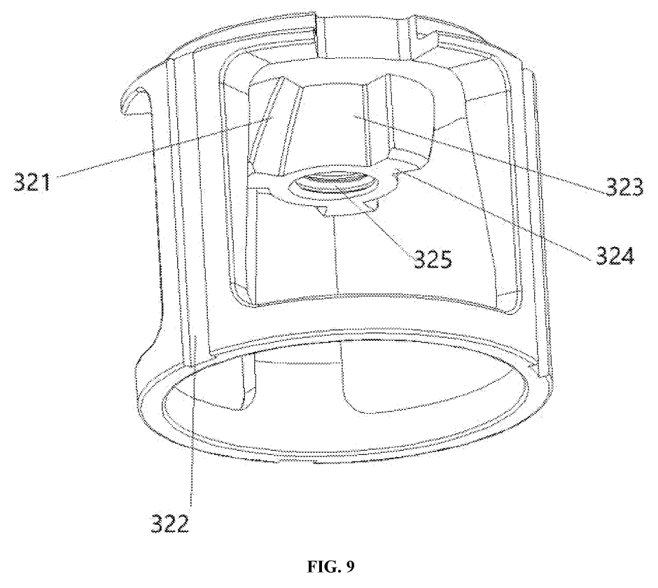

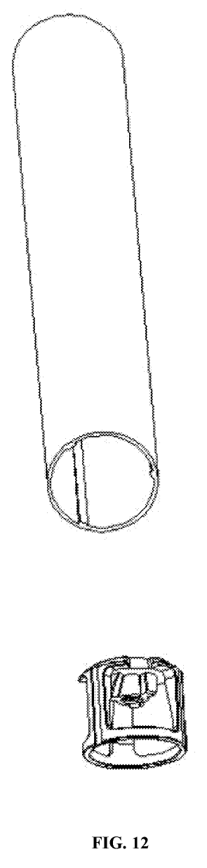

As shown in FIGS. 1-12, in this embodiment, starting with the major assembly: specifically, the outer tube 200 is provided with an outer end cap 210, and the inner tube 100 is provided with an inner end cap 110. The inner end cap 110 and the inner tube 100 form a chamber, and the outer end cap 210 is located within this chamber, with the two preferably connected by threads.

For the inner tube 100, its upper part is fixed with a fixed base 310. The fixed base 310 includes a base seat 315 that overlaps inside the inner tube 100 and is fixed at the inner tube 100. The base seat 315 extends upward to form a necking cavity, which constitutes one type of interference structure 340. A waist-shaped sliding groove 311 is formed on the fixed base 310, and the entire fixed base 310 is a hollow structure.

For the outer tube 200 and the sliding frame 320, one is provided with a sliding block, and the other is provided with a sliding groove, enabling axial relative sliding between the two. For example, a sliding block 220 is formed protruding axially along the inner wall of the outer tube 200, and then a matching sliding cavity 322 is provided on the outer wall of the sliding frame 320, so that during their interaction, the sliding block 220 slides axially along the sliding cavity 322. In this embodiment, the sliding frame 320 is a hollow cylinder, with several assembly frames formed on the outer side of the cylinder to accommodate expansion blocks 330. Inside the sliding frame 320, adjacent to the center, a central cylinder 323 is formed. Then, on the periphery of the central cylinder 323, several protruding limit parts 321 are formed circumferentially. Each limit part 321 has a slope adjacent to the adjacent limit part 321, creating a rotational tendency. A corresponding rotating part 312 is set inside the fixed base 310 to provide the basis for subsequent unlocking.

To connect the sliding frame 320 and the fixed base 310, one of the sliding frame 320 or fixed base 310 is provided with a threaded hole 325 extending along the centerline of the telescopic tube, and the other is provided with a screw rod 313. In the drawings of this embodiment, the central cylinder 323 of the sliding frame 320 is shown with a threaded hole for illustration, and then a screw rod is shown adjacent to the fixed base 310 inside the inner tube.

Furthermore, it further includes an elastic member 314 located between the sliding frame 320 and the fixed base 310. When the inner tube 100 and the outer tube 200 are extended, the elastic member 314 tends to push the expansion block 330 outward. In practical use, after the screw rod 313 passes through the threaded hole, its end extends into the base seat. A limit plate is fixed to the end of the screw rod 313 by a fastener, and an auxiliary elastic member 314 is arranged between the limit plate and the base seat. The auxiliary elastic member 314 is sleeved over the screw rod 313, helping the screw rod 313 to stably retract into the tube cavity of the base seat. This causes the sliding frame 320, under the action of the auxiliary elastic member 314, to have a tendency to screw into the fixed base 310. Consequently, when not controlled by an external force, the inner tube 100 and the outer tube 200 tend to be locked, meaning the expansion block 330 tends to expand outward and tightly interfere with the inner surface of the outer tube 200. The fastener is preferably a screw.

In this embodiment, due to the addition of the auxiliary elastic member 314, which is initially in a compressed state, when the inner tube 100 and the outer tube 200 are extended, the sliding frame 320 is driven by the fixed base 310 and moves closer to the fixed base 310. The compressed auxiliary elastic member 314 (e.g., a spring) is eager to reset, thereby driving the sliding frame 320 and the fixed base 310 to approach each other more quickly, accelerating the locking process.

To prevent disconnection during extension or rotation, the fixed base 310 extends outward to form a limit body 317, and the end of the outer tube 200 is provided with an edge closing structure 230 to be engaged with the hook of the limit body 317. In this embodiment, during the rotation of the fixed base 310, when it rotates to a certain position, the limit body 317 becomes caught in the edge closing structure 230 and cannot continue rotating. At this point, the inner tube 100 and the outer tube 200 are in an extended state.

To facilitate variation and production, there are several expansion blocks 330. The tops of the expansion blocks 330 extend to form a slot, and the several expansion blocks are connected by a sealing gasket 350 located in the slot. The arrangement of the sealing gasket 350 allows the plurality of expansion blocks 330 to be assembled together. At this time, several assembly grooves corresponding to the expansion blocks 330 may be set on the outside of the sliding frame 320, making them match during retraction and resulting in a more aesthetically pleasing internal structure.

In this embodiment, through the arrangement of a plurality of methods, the unlocking of the entire telescopic tube is made more convenient. Moreover, the entire locking mechanism is set between the inner tube and the outer tube, not easily exposed, making it more aesthetically pleasing.

To enable the sliding frame 320 to slide up and down within the outer tube 200, one of the outer tube 200 or the sliding frame 320 forms a sliding block 220 through a protrusion along the axial direction of the outer tube 200, while the other forms a sliding cavity 322 through a groove. The two cooperate to achieve relative sliding.

Embodiment 6

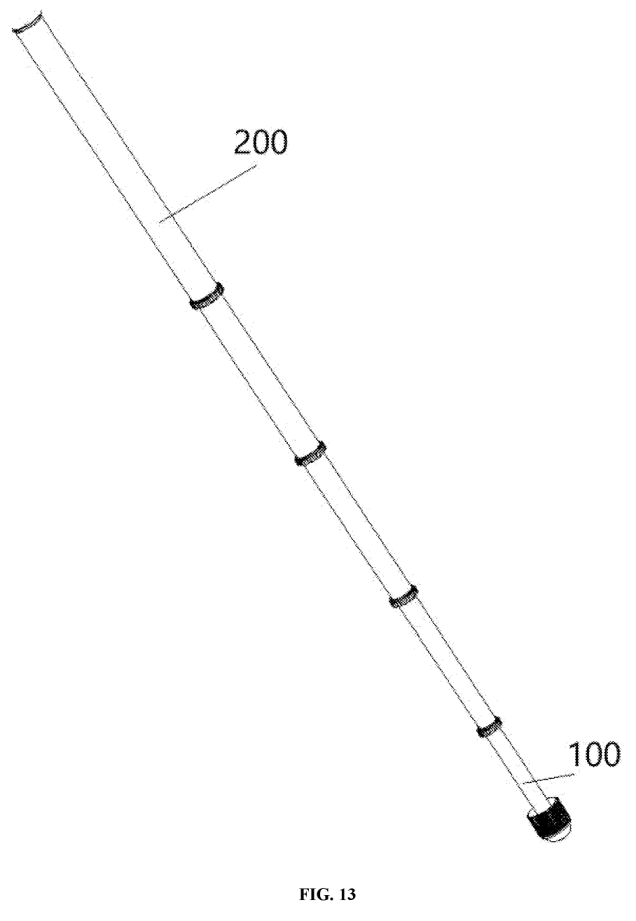

Referring to FIG. 13, an infinitely adjustable telescopic rod in this embodiment includes a plurality of telescopic tubes as described above, with each adjacent pair of telescopic tubes forming a set of inner tube 100 and outer tube 200. In this case, the telescopic tubes may be arranged in one, two, three, or more sets, with the number selected based on the required length of the telescopic rod.

Embodiment 7

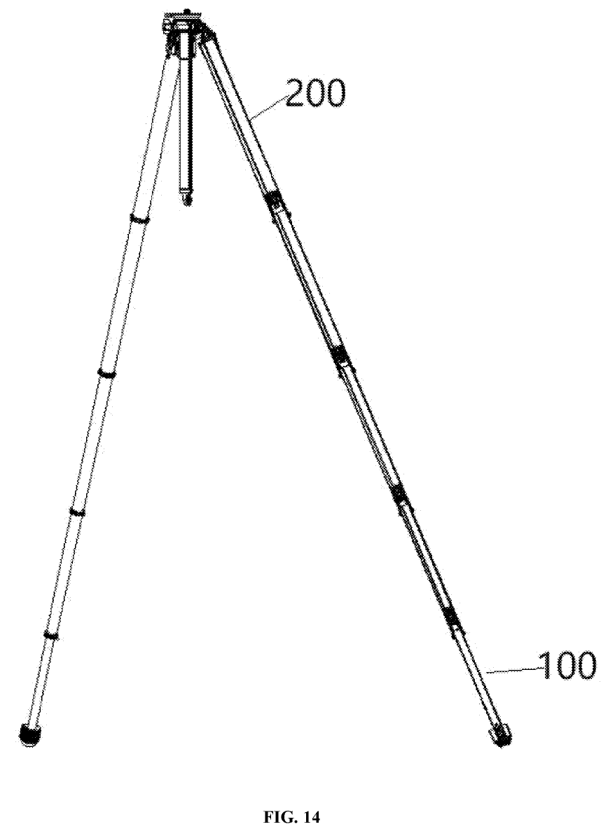

This embodiment discloses an application of the telescopic tube. As shown in FIG. 14, it is used in a tripod, forming part of the three support legs of the tripod. Alternatively, the telescopic rod from Embodiment 6 may constitute the support leg.

Of course, the aforementioned telescopic tubes and telescopic rods may also be used in outdoor sports products or daily items such as monopods, selfie sticks, walking sticks, trekking poles, or canopy poles.

In the description of the present disclosure, it shall be appreciated that directional terms such as "front, rear, up, down, left, right", "transverse, vertical, perpendicular, horizontal" and "top, bottom" generally refer to the orientation or positional relationship shown in the accompanying drawings, and are only for the convenience of describing the present disclosure and simplifying the description. Unless otherwise specified, these directional terms do not indicate or imply that the device or element referred to must have a specific orientation or be constructed and operated in a specific orientation, and thus should not be construed as limiting the scope of protection of the present disclosure; the directional terms "inner, outer" refer to the inside and outside relative to the contour of each component itself.

For ease of description, spatial relative terms such as "on", "above", "on the surface of", "upper" may be used herein to describe the spatial positional relationship of one device or feature relative to other devices or features as shown in the figures. It shall be appreciated that spatial relative terms are intended to encompass different orientations of the device in use or operation, in addition to the orientation depicted in the drawings. For example, if a device in the drawing is inverted, a device described as being "above" or "on" other devices or structures would then be oriented as "below" or "under" the other devices or structures. Thus, the exemplary term "above" may encompass both "above" and "below" orientations. The device may also be oriented in other ways (rotated 90 degrees or at other orientations), and the spatial relative descriptions used herein should be interpreted accordingly.

Furthermore, it should be noted that the use of terms such as "first", "second" to define components is for the purpose of distinguishing between corresponding components for convenience. Unless otherwise stated, the above terms have no special meaning and should not be construed as limiting the scope of protection of the present disclosure.

The above descriptions are only preferred embodiments of the present disclosure and are not intended to limit the present disclosure. For those skilled in the art, the present disclosure may have various modifications and changes. Any modifications, equivalent substitutions, improvements and the like made within the spirit and principles of the present disclosure shall be included within the scope of protection of the present disclosure.

What is claimed is:

1. A telescopic tube, comprising: an inner tube, an outer tube, and a locking mechanism located between the inner tube and the outer tube, wherein the locking mechanism comprises a fixed base secured to an end of the inner tube, a sliding frame disposed inside the outer tube and sliding axially along the outer tube, and an expansion block arranged adjacent to the outer tube, wherein the sliding frame and the fixed base are in helical fit in direction along a centerline of the telescopic tube, and when the inner tube and the outer tube are extended to any position, the sliding frame drives the expansion block to approach the fixed base, while an interference force is generated between the expansion block and the fixed base, enabling the expansion block to expand outward and tightly interfere with the outer tube; and
wherein when the inner tube rotates, the fixed base rotates with a center of the inner tube as an axis, pushing the sliding frame to slide axially, the inner tube and the outer tube retract, the expansion block moves away from the fixed base, the expansion block recesses inward and approaches the sliding frame, and tends to disengage from interference with the outer tube, wherein a rotation range of the inner tube is less than or equal to 270°.

2. The telescopic tube according to claim 1, wherein an interference structure is formed on the fixed base and/or the expansion block, and when the inner tube and the outer tube are extended, the sliding frame and the fixed base approach each other, and the interference structure forms the interference force for locking.

3. The telescopic tube according to claim 2, wherein the interference structure is an interference surface arranged axially long the telescopic tube, and the interference surface acts in an axial direction through the inner tube and the outer tube to adjust a magnitude of the interference force.

4. The telescopic tube according to claim 2, wherein the interference structure is an inclined surface sloping from the outer tube toward the inner tube, both the fixed base and the expansion block are provided with the interference structures, and two inclined surfaces on the fixed base and the expansion block are arranged parallel to each other.

5. The telescopic tube according to claim 4, wherein the fixed base comprises a base seat and a sliding sleeve extending from the base seat toward the outer tube, and the sliding sleeve forms a necking cavity with a gradually decreasing diameter toward the outer tube.

6. The telescopic tube according to claim 5, further comprising a plurality of rotating parts extending from the sliding sleeve toward the centerline of the telescopic tube, and the sliding frame is provided with limit parts corresponding to the rotating parts.

7. The telescopic tube according to claim 6, wherein a limit step facing the rotating part is formed at the limit part, and the inner tube, during rotation, drives the rotating part located within the limit step to disengage from the limit step.

8. The telescopic tube according to claim 7, wherein an interference incline is formed on an outer wall of the limit step and/or an inner wall of the rotating part.

9. The telescopic tube according to claim 1, wherein a preload structure is arranged inside the expansion block, and the fixed base is provided with a sliding groove corresponding to the preload structure.

10. The telescopic tube according to claim 9, wherein the sliding groove forms an arcuate trajectory with an upward and downward trend, and the preload structure rotates along the arcuate trajectory, enabling the expansion block to abut and interfere with the outer tube.

11. The telescopic tube according to claim 9, wherein the fixed base comprises a base seat and a sliding sleeve extending from the base seat toward the outer tube, the sliding groove is arranged on an outer wall of the sliding sleeve, rotating parts are arranged on an inner wall of the sliding sleeve, and the sliding groove and the rotating parts are offset in the axial direction of the telescopic tube to reduce strength weakening caused by simultaneous action.

12. The telescopic tube according to claim 11, wherein one of the sliding frame and the fixed base is provided with a threaded hole extending along the direction of the centerline of the telescopic tube, and the other is provided with a threaded rod matching the threaded hole.

13. The telescopic tube according to claim 12, wherein an end of the threaded rod is fixed with a limit plate by a fastener, an elastic member is provided between the limit plate and the base seat of the fixed base, and the elastic member is sleeved over the threaded rod and applies a biasing force toward the fixed base to the sliding frame, enabling the telescopic tube to maintain a locking tendency when no external force is applied and to accelerate locking when extended.

14. The telescopic tube according to claim 1, wherein the outer tube is provided with an outer end cap, the inner tube is provided with an inner end cap, the inner end cap and the inner tube together define a chamber, the outer end cap is located within the chamber, and the outer end cap is threadedly connected to the inner end cap.

15. The telescopic tube according to claim 1, further comprising an elastic member located between the sliding frame and the fixed base, wherein the elastic member tends to push the expansion block outward when the inner tube and the outer tube are extended.

16. The telescopic tube according to claim 1, wherein the fixed base extends outward to form a limit body, and an end of the outer tube is provided with an edge closing structure configured to be engaged with the limit body.

17. The telescopic tube according to claim 1, wherein there are several expansion blocks, tops of the expansion blocks extend to form a slot, and the several expansion blocks are connected by a sealing gasket located within the slot.

18. The telescopic tube according to claim 1, wherein along the axial direction of the outer tube, one of the outer tube and the sliding frame forms a sliding block through a protrusion, and the other forms a sliding cavity through a groove.

19. An infinitely adjustable telescopic rod, comprising a plurality of telescopic tubes according to claim 1, wherein the plurality of telescopic tubes are sequentially nested along an axial direction, wherein among adjacent two telescopic tubes, an outer telescopic tube constitutes the outer tube, and an inner telescopic tube constitutes the inner tube.

20. An application of the telescopic tube according to claim 1, comprising an application of the telescopic tube in a tripod, a monopod, a selfie stick, a walking stick, a trekking pole, or a canopy pole.
